(19) United States
(12) Patent Application Publication
(10) Pub. No.: US 2026/0011016 A1
(43) Pub. Date: Jan. 8, 2026

(54) VIDEO PROCESSING SYSTEM AND VIDEO PROCESSING METHOD

(71) Applicant: NIPPON TELEGRAPH AND TELEPHONE CORPORATION, Tokyo (JP)

(72) Inventors: Toshihito FUJIWARA, Musashino-shi, Tokyo (JP); Tatsuya FUKUI, Musashino-shi, Tokyo (JP); Ryota SHIINA, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/873,310

(22) PCT Filed: Jun. 14, 2022
(86) PCT No.: PCT/JP2022/023725

§ 371 Date: Dec. 9, 2024

(51) Int. Cl. G06T 7/149; G06T 11/60; G06V 10/46

(52) U.S. Cl. CPC G06T 7/149; G06T 11/60; G06V 10/46; G06T 2207/10016

(57) ABSTRACT

An object of the present disclosure is to reduce a time required for object extraction and clipping processing. The present disclosure provides a video processing system including a software processing unit configured to detect an object included in at least some of input images included in an input video and extract a contour of the object, and a hardware processing unit configured to generate mask information for clipping out the object from the input images included in the input video by using the contour extracted by the software processing unit, in which the software processing unit and the hardware processing unit perform processing independently in parallel.

### TECHNICAL FIELD

The present disclosure relates to a video processing technique for clipping out a target object such as a person from a background in a video captured by a camera or the like.

### BACKGROUND ART

In a real-time communication tool using video and audio used in a Web conference or the like, a technique for clipping out a video from a person and synthesizing the video with another background is used. Such a clipping technique can achieve communication not restricted by a place by hiding a background which is not inherently desired to be projected, and allows communication to proceed more smoothly by replacing the background with a background suitable for the communication. Various methods are known for such object extraction and clipping processing.

Classical methods therefor include an area division method of dividing an image into a plurality of areas by using a feature amount and extracting an object, an area expansion method of searching for a neighboring similar area from a pixel to be a starting point and expanding the area, a division merging method of combining the area division method and the area expansion method, a contour method of extracting a contour line, an optical flow method of extracting a movement area, and the like (see, for example, NPL 1). As other approaches, human thinking simulation methods such as fuzzy theory, deep learning, and a genetic algorithm (see, for example, NPL 2) are well known.

In real-time communication using a video and audio, video and audio processing such as object extraction and clipping processing of a person is important. Thereby, smoother communication can be performed by combining with an appropriate background or the like regardless of a place. The above-described video processing is required to be executed in a processing time that satisfies requirements of real-time communication using the video and audio.

For example, assuming a remote ensemble in real-time video and audio communication, and assuming an allowed time deviation of approximately 1/10 per beat in a 240 beat per minute (BPM) song, and a time for one beat of 60 seconds/120 BPM=0.25 seconds, 1/10 thereof is 0.025 seconds, that is, approximately 25 milliseconds. For this reason, in order to satisfy the requirements of real-time performance, it is desirable to execute the processing in a processing time of less than 25 milliseconds.

The time of 25 milliseconds includes, from a subject movement in a camera, all of an imaging time to a shutter release, a processing time inside the camera, a transmission time via a network, a video and audio processing time in a communication system itself, and the like.

Among these, the above-described object extraction and clipping processing are included in the video and audio processing time, and processing for dividing and displaying a video, and the like are also required for the video and audio processing time. Thus, it is considered that a processing time which can be used for object extraction and clipping processing is several milliseconds or less.

The object extraction and clipping processing include reception and data processing of image data for one screen (frame) of a video. At this time, for example, when the video is data of 60 frames per second, a data reception time of 1/60 seconds=16.7 milliseconds is required, and a data processing time is additionally required. In the existing research, it is reported that this processing time is several tens of milliseconds or more (see, for example, NPL 3). For this reason, the above-described requirements of a processing time that can be used for object extraction and clipping processing are not satisfied.

For this reason, in real-time communication using a video and audio in a scene with severe delay requirements such as a remote concert, object extraction and clipping processing cannot be performed, and smooth communication by combining with an appropriate background or the like is hindered.

### CITATION LIST

### Non Patent Literature

[NPL 1] Freixenet, Jordi, et al. “Yet another survey on image segmentation: Region and boundary information integration.” European conference on computer vision. Springer, Berlin, Heidelberg, 2002.

[NPL 2] Chouhan, Siddharth Singh, Ajay Kaul, and Uday Pratap Singh. “Soft computing approaches for image segmentation: a survey.” Multimedia Tools and Applications 77.21 (2018): 28483-28537

[NPL 3] Ryu, Sangwoo, Kyungchan Ko, and James Won-Ki Hong. “Performance Analysis of Applying Deep Learning for Virtual Background of WebRTC-based Video Conferencing System.” 2021 22nd Asia-Pacific Network Operations and Management Symposium (APNOMS). IEEE, 2021.

### SUMMARY OF INVENTION

### Technical Problem

An object of the present disclosure is to reduce a time required for extraction processing and clipping processing of an object.

### Solution to Problem

In the present disclosure, a software processing unit performs advanced object detection and contour extraction, and a hardware processing unit performs processing for generating mask information for clipping. Further, it is possible to reduce a time for object extraction and clipping processing by performing these processes in a pipeline.

A video processing system of the present disclosure includes
a software processing unit configured to detect an object included in at least some of input images included in an input video and extract a contour of the object, and
a hardware processing unit configured to generate mask information for clipping out the object from the input images included in the input video by using the contour extracted by the software processing unit,
in which the software processing unit and the hardware processing unit perform processing independently in parallel.

A communication method of the present disclosure includes
causing a software processing unit to detect an object included in at least some of input images included in an input video and extract a contour of the object, and
causing a hardware processing unit to generate mask information for clipping out the object from the input images included in the input video by using the contour extracted by the software processing unit,
in which the software processing unit and the hardware processing unit perform processing independently in parallel.

The software processing unit may extract the contour of the object using a first input image included in the input video, and the hardware processing unit may generate mask information of a second input image that arrives after the first input image included in the input video by correcting the contour extracted from the first input image or mask information generated from the first input image. In this case, the hardware processing unit may perform the correction for each predetermined line section of each input image included in the input video.

The mask information may include contour information by which the contour of the object is able to be specified, in an arbitrary input image included in the input video. The contour information may include coordinates included in the contour of the object in an arbitrary input image included in the input video, or may include a vector indicating the contour of the object in the arbitrary input image included in the input video. In addition, the mask information may be a mask image that covers areas other than the object in an arbitrary input image included in the input video.

The hardware processing unit may generate, as the mask information, a composite image in which areas other than the object are different in each input image included in the input video.

The above disclosures can be combined as far as possible.

### Advantageous Effects of Invention

According to the present disclosure, it is possible to reduce a time required for object extraction and clipping processing. For this reason, according to the present disclosure, in real-time communication using a video and audio in a scene with severe delay requirements such as a remote concert, it is possible to perform smooth communication by performing object extraction and clipping processing and combining with an appropriate background or the like.

### BRIEF DESCRIPTION OF DRAWINGS

FIG. 1 illustrates a configuration example of a video processing system according to the present disclosure.

FIG. 2 is a diagram illustrating processing in a software processing unit.

FIG. 3 is a diagram illustrating processing in a hardware processing unit.

FIG. 4 is a diagram illustrating processing in the hardware processing unit.

FIG. 5 is a diagram illustrating cooperative processing of the software processing unit and the hardware processing unit.

FIG. 6 illustrates an example of a mask image generation method.

FIG. 7 is a diagram illustrating each processing in the mask image generation method.

### DESCRIPTION OF EMBODIMENTS

Hereinafter, embodiments of the present disclosure will be described in detail with reference to the drawings. The present disclosure is not limited to the embodiments described below. The embodiments are merely examples, and the present disclosure can be implemented in various modified and improved modes based on knowledge of those skilled in the art. Constituent elements with the same reference numerals and signs in the present specification and the drawings represent the same constituent elements.

### First Embodiment

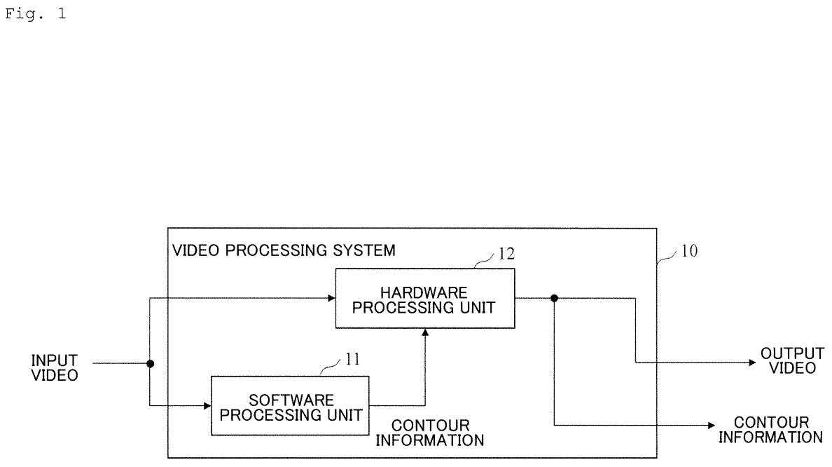

FIG. 1 illustrates a configuration example of a video processing system of the present disclosure. A video processing system 10 of the present disclosure clips out an object included in an image (may be referred to as an input image) of each screen (frame) included in an input video from the image, replaces the image (may be referred to as a composite image) of the clipped-out object with an image of each screen (frame), and outputs the image as an output video. The video processing system 10 of the present disclosure performs the object extraction and clipping processing by cooperative processing between a software processing unit 11 and a hardware processing unit 12. The hardware processing unit 12 can use a field programmable gate array (FPGA).

A video processing method of the present disclosure includes
causing the software processing unit 11 to detect an object included in at least some of input images included in an input video and extract a contour of the object, and
causing the hardware processing unit 12 to generate mask information for clipping out the object from each input image included in the input video by using the contour extracted by the software processing unit 11, and
the software processing unit 11 and the hardware processing unit 12 perform processing independently in parallel.

Here, the mask information is arbitrary information making it possible to clip out an object from an input image, and may include contour information making it possible to specify the contour of the object. For example, the mask information may include coordinates indicating at least a part of the contour of the object, or may include a vector indicating the contour of the object. In this embodiment, an example of the mask information is a mask image that covers areas other than the object in the input image.

The video processing system 10 may be an integrated device or may be constituted by a plurality of devices. For example, in the video processing system 10, the software processing unit 11 and the hardware processing unit 12 may be physically separated. In this case, even when the software processing unit 11 and the hardware processing unit 12 are disposed at remote locations, the system of the present disclosure can be configured by transmitting contour information of an object via an information transmission medium such as a communication network.

Further, the software processing unit 11 can be implemented using a computer and a program, and the program can be recorded on a recording medium or provided through a network. The video processing program of the present disclosure causes a computer to function as the software processing unit 11, and causes the software processing unit 11 and the hardware processing unit 12 to perform processing independently in parallel.

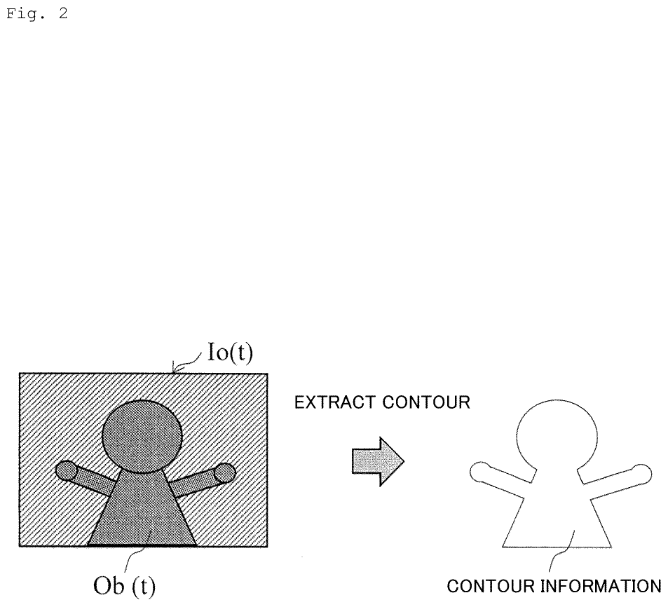

As illustrated in FIG. 2, the software processing unit 11 performs advanced detection of an object Ob(t) and contour extraction processing for the object Ob(t) on an image lo(t) at an arbitrary point in time t included in a video. Thereby, contour information necessary for clipping processing of the object Ob(t) can be obtained. The software processing unit 11 passes the contour information to the hardware processing unit 12. In this specification, the image lo(t) included in the video at the arbitrary point in time t may be referred to as an input image.

An algorithm for detecting the object Ob(t) and an algorithm for extracting the contour of the object Ob(t) do not matter. The software processing unit 11 may perform processing on every image lo(t) of the video or may perform processing on every several images lo(t).

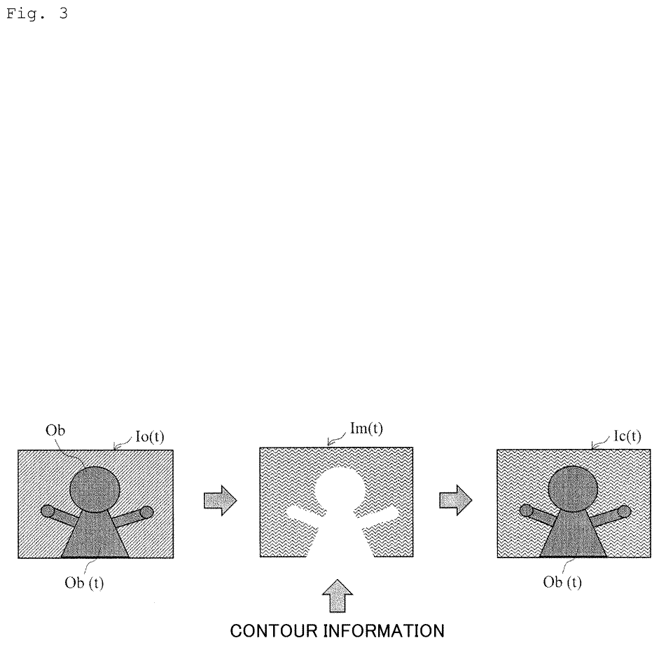

The hardware processing unit 12 generates a mask image lm(t) having a transparent area of the object Ob(t) from the image lo(t) as illustrated in FIG. 3 by using the contour information from the software processing unit 11. Then, the hardware processing unit 12 superimposes the mask image lm(t) on a layer on the image lo(t). Thereby, a composite image Ic(t) obtained by combining the image of the object Ob(t) and the mask image lm(t) is generated.

Here, the area other than the object Ob(t) in the mask image lm(t) may be a plain area, but may be an arbitrary image. For example, the hardware processing unit 12 may perform synthesis processing with a background image different from the background of the image lo(t). Further, the hardware processing unit 12 may output mask information and/or the image of the object Ob(t).

The present disclosure has the following advantages by providing the software processing unit 11.
It is possible to perform advanced detection of the object Ob(t) and contour extraction processing which are difficult to perform by hardware processing.
It is possible to easily change an algorithm of the detection of the object Ob(t) and the contour extraction processing which are difficult to perform by the hardware processing.

The present disclosure has the following advantages by providing the hardware processing unit 11.
It is possible to implement low delay processing which cannot be implemented by software processing.

The present disclosure has the following advantages by providing both the software processing unit 11 and the hardware processing unit 12.
It is possible to utilize the above-described advantages of the software processing unit 11 and the above-described advantages of the hardware processing unit 12 as they are.
As compared with the case of implementation using a single processing unit, it is possible to minimize the scale of a circuit mounted on the hardware processing unit 12 and to facilitate mounting on a device.

### Second Embodiment

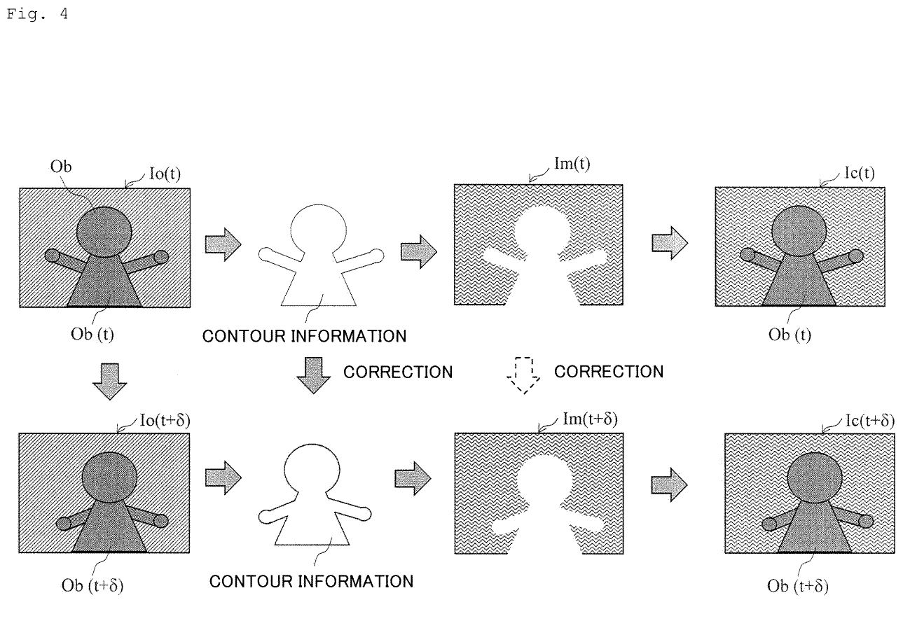

As illustrated in FIG. 4, in a video, an object Ob(t) of an image lo(t) changes to Ob(t+δ) of an image lo(t+δ). Consequently, in this embodiment, a hardware processing unit 12 uses arbitrary information generated by one or both of a software processing unit 11 and the hardware processing unit 12 at the time of generating mask information. Specifically, a mask image lm(t+δ) at time t+δ is generated by correcting contour information at time t or a mask image lm(t).

The hardware processing unit 12 can correct one or both of the contour information at time t and the mask image lm(t) for each n line (assuming several to several hundred) in the lateral direction of the image lo(t+δ) of an input video based on contour information from one or both of the software processing unit 11 and the hardware processing unit 12, generate a new mask image lm(t+δ), and output an output video of a composite image Ic(t+δ) obtained by extracting only the object Ob(t+δ) from the image lo(t+δ).

A method of correcting contour information is not limited. Further, a mask image Im may be corrected instead of correcting the contour information.

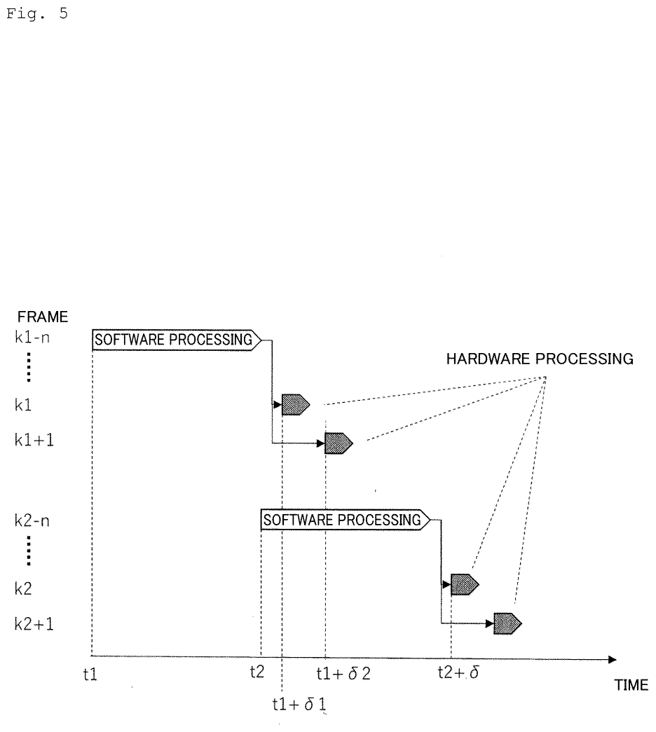

A flow of processing for image data of one screen (frame) of a video will be described with reference to FIG. 5. The software processing unit 11 performs extraction processing for the contour of an object Ob(t1) on an image lo(t1) of a k1−n frame at time t1 and transfers contour information to the hardware processing unit 12. At the time t2, the software processing unit 11 performs processing of an image lo(t2) of a k2−n frame. The time T2 is, for example, after the software processing unit 11 completes the processing of the image lo(t1). However, the present disclosure is not limited thereto. For example, the software processing unit 11 may periodically execute processing to update the contour information. For example, the software processing unit 11 may execute processing in parallel to update the contour information.

The hardware processing unit 12 performs processing using the latest contour information in the software processing unit 11. For example, the hardware processing unit 12 corrects one or both of contour information of the image lo(t1) of the k1−n frame and the mask image lm(t1) from the software processing unit 11 with respect to an image lo(t1+δ1) input of a k1 frame at time t1+δ1 to perform processing for generating a mask image lm(t1+δ1) and a composite image Ic(t1+δ1).

An arrival time t1+δ2 of a k1+1 frame is after the time t2 when the software processing unit 11 starts the processing of the image lo(t2) of the k2−n frame. In this case, since the processing of the image lo(t2) by the software processing unit 11 is not completed and one or both of the contour information and the mask image lm(t2) are not updated, the hardware processing unit 12 can use, for the processing of the k1+1 frame, one or both of the contour information and the mask image lm(t1) extracted in the k1−n frame by the software processing unit 11 in the frame processing of k1.

Here, in the correction performed by the hardware processing unit 12, information processed in any past frame generated in the hardware processing unit 12 can be used. For example, in the hardware processing for the k1+1 frame, mask information such as a mask image generated in the hardware processing of the k1 frame may be used instead of the contour information extracted in the k1−n frame.

The same processing is also performed on k2−n, k2, k2+1 frames. Through such pipeline processing, a delay from the input of a video to the output of the video for a frame at a certain time in the hardware processing unit 12 can be minimized.

### Third Embodiment

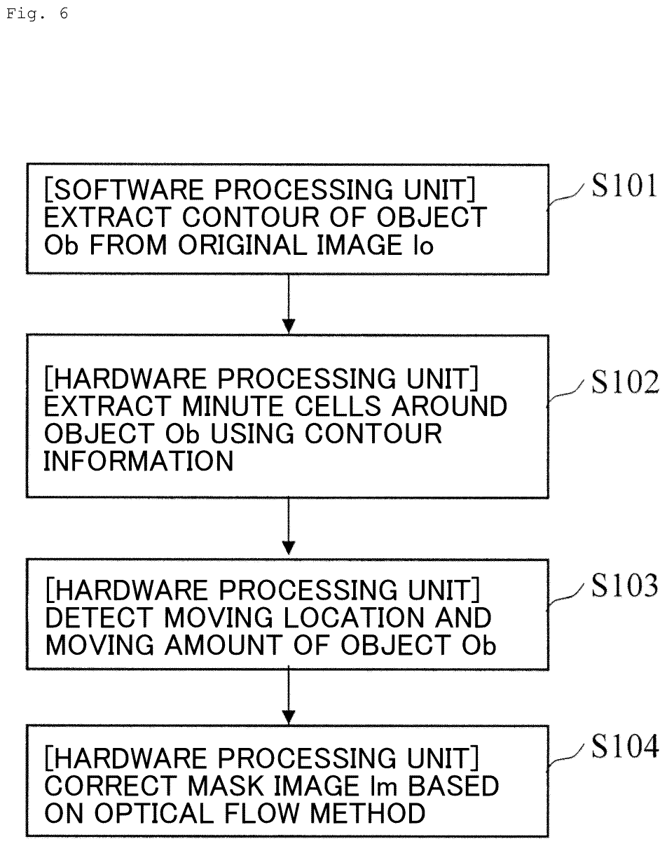

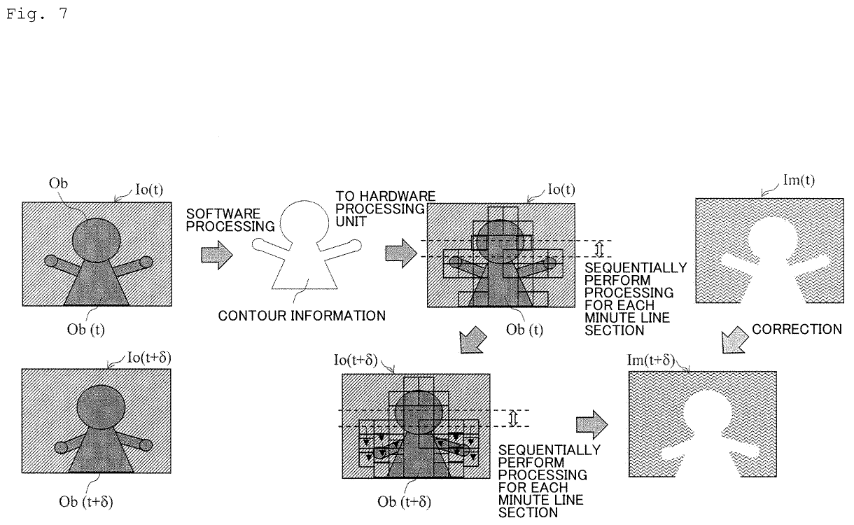

FIG. 6 illustrates an example of a method of generating a mask image lm(t+δ) in a second embodiment. In this embodiment, an example of a correction processing procedure using an optical flow method is described with reference to FIG. 7.

### Step S101

An object Ob(t) is detected by a software processing unit 11 with respect to an image lo(t) at time t, and the contour of the object Ob(t) is extracted (S101). Thereby, contour information of the object Ob(t) is generated, and the contour information is transferred to a hardware processing unit 12.

### Step S102

The hardware processing unit 12 extracts minute cells around a boundary of the object Ob(t) from the image lo(t) based on the contour information.

### Step S103

The hardware processing unit 12 detects areas having high similarity from an image lo(t+δ) for each of the minute cells extracted from the object Ob(t) to calculate a moving location and a moving amount thereof. Specifically, similarity can be detected by performing correlation operation on pixels in the vicinity of the original positions of the minute cells with respect to the image lo(t+δ).

### Step S104

The hardware processing unit 12 can correct a mask image lm(t) at time t from the moving location and the moving amount of the object Ob(t) and generate a new mask image lm(t+δ).

Here, the extraction of the minute cells can be sequentially performed for each minute line section without waiting for the completion of the arrival of image data of one screen (frame) in video data. Here, the minute lines can be set to be predetermined arbitrary n lines. The minute line sections may be superimposed on each other. That is, overlapping may occur. Further, although an example using an optical flow method is described in this embodiment, the present disclosure may use, for example, an area expansion method other than the optical flow method.

By performing processing for each minute line section, it is possible to reduce a waiting time of an arrival time of image data of one screen (frame) and reduce a processing delay.

### Effects

The present disclosure can achieve both a feature that advanced object detection and contour extraction processing, which are the above-described advantages of the software processing unit 11, and the algorithm thereof can be easily changed and low delay processing that cannot be implemented by software processing, which is the above-described advantage of the hardware processing unit 12, by providing both the software processing unit 11 and the hardware processing unit 12. Further, as compared with the case of implementation using a single processing unit, it is possible to minimize the scale of a circuit mounted on the hardware processing and to facilitate mounting on a device.
Through pipeline processing of the software processing unit 11 and the hardware processing unit 12, a delay from the input of a video to the output of the video for a frame at a certain time in the hardware processing unit 12 can be minimized.
In real-time communication using a video and audio in a scene with severe delay requirements such as a remote concert, it is possible to perform smooth communication by performing object extraction and clipping processing and combining with an appropriate background or the like.

As described above, in the present disclosure, cooperative processing between the software processing unit 11 and the hardware processing unit 12 is performed. In particular, the software processing unit 11 performs advanced object detection and contour extraction processing, and the hardware processing unit 12 performs correction processing and the like, thereby generating mask information for clipping. Further, a reduction in the processing time is achieved by performing these processes in a pipeline. Thereby, in real-time communication using a video and audio in a scene with severe delay requirements such as a remote concert, it is possible to achieve smooth communication by performing object extraction and clipping processing and combining with an appropriate background or the like.

### REFERENCE SIGNS LIST

10 Video processing system
11 Software processing unit
12 Hardware processing unit

1. A video processing system comprising:
a software processing unit configured to detect an object included in at least some of input images included in an input video and extract a contour of the object; and
a hardware processing circuit configured to generate mask information for clipping out the object from the input images included in the input video by using the contour extracted by the software processing unit,
wherein the software processing unit and the hardware processing circuit perform processing independently in parallel.

2. The video processing system according to claim 1, wherein
the software processing unit extracts the contour of the object using a first input image included in the input video, and
the hardware processing circuit generates mask information of a second input image that arrives after the first input image included in the input video by correcting the contour extracted from the first input image or mask information generated from the first input image.

3. The video processing system according to claim 2, wherein
the hardware processing circuit performs the correction for each predetermined line section of each input image included in the input video.

4. The video processing system according to claim 1, wherein
the mask information includes contour information by which the contour of the object is able to be specified, in an arbitrary input image included in the input video.

5. The video processing system according to claim 1, wherein
the mask information is a mask image that covers areas other than the object in an arbitrary input image included in the input video.

6. The video processing system according to claim 1, wherein the hardware processing circuit generates, as the mask information, a composite image in which areas other than the object are different in each input image included in the input video.

7. A video processing method comprising:
causing a software processing unit to detect an object included in at least some of input images included in an input video and extract a contour of the object; and
causing a hardware processing unit to generate mask information for clipping out the object from the input images included in the input video by using the contour extracted by the software processing unit,
wherein the software processing unit and the hardware processing unit perform processing independently in parallel.

8. A video processing program performing:
causing a software processing unit to detect an object included in at least some of input images included in an input video and extract a contour of the object; and
causing a hardware processing unit to generate mask information for clipping out the object from the input images included in the input video by using the contour extracted by the software processing unit,
wherein the program causes the software processing unit and the hardware processing unit to perform processing independently in parallel.
